(19) United States
(12) Patent Application Publication
(10) Pub. No.: US 2025/0113392 A1
(43) Pub. Date: Apr. 3, 2025

(54) SYSTEMS AND METHODS FOR AUGMENTED REALITY COMMUNICATION BASED ON DATA CHANNEL

(71) Applicant: ZTE CORPORATION, Shenzhen (CN)

(72) Inventor: Hao DONG, Shenzhen (CN)

(73) Assignee: ZTE CORPORATION, Shenzhen (CN)

(21) Appl. No.: 18/979,076

(22) Filed: Dec. 12, 2024

Related U.S. Application Data
(63) Continuation of application No. PCT/CN2022/117705, filed on Sep. 8, 2022.

(51) Int. Cl. H04W 76/10; H04L 65/1016; H04L 65/65

(52) U.S. Cl. CPC H04W 76/10; H04L 65/1016; H04L 65/65

(57) ABSTRACT

Presented are systems and methods for augmented reality (AR) communication based on data channel. A first wireless communication device may communicate with a wireless communication node to share computer-generated perceptual information via a data channel. A media content can be rendered with the computer-generated perceptual information.

### CROSS-REFERENCE TO RELATED APPLICATION

This application claims the benefit of priority under 35 U.S.C. § 120 as a continuation of PCT Patent Application No. PCT/CN2022/117705, filed on Sep. 8, 2022, the disclosure of which is incorporated herein by reference in its entirety.

### TECHNICAL FIELD

The disclosure relates generally to wireless communications, including but not limited to systems and methods for augmented reality (AR) communication based on data channel.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A first wireless communication device (e.g., a user equipment (UE)) may communicate with a wireless communication node (e.g., an application server) to share computer-generated perceptual information (e.g., AR specific data, which can be locally generated, or received from a UE B) via a data channel (e.g., an application data channel). A media (e.g., an audio media or a video media) content can be rendered (e.g., combines media content with AR specific data) with the computer-generated perceptual information. A media function (e.g., a data channel (DC) media function) of the wireless communication node can communicate with a rendering function (e.g., an AR rendering function) of the wireless communication node to acquire the computer-generated perceptual information, and to send the computer-generated perceptual information to the wireless communication device.

In some embodiments, the first wireless communication device may establish the data channel with the wireless communication node. The first wireless communication device may send a request for the computer-generated perceptual information via the data channel to the wireless communication node. The first wireless communication device may receive the computer-generated perceptual information via the data channel from the wireless communication node.

In some embodiments, the first wireless communication device may generate (e.g., locally generate) the media content. The first wireless communication device may render the media content with the computer-generated perceptual information. The first wireless communication device (e.g., a UE A) may send the rendered media content via a media channel (e.g., a real-time transport protocol (RTP) channel) to a second wireless communication device (e.g., a UE B).

In some embodiments, the first wireless communication device may receive the media content via a media channel from a second wireless communication device. The first wireless communication device may render the received media content with the computer-generated perceptual information. The first wireless communication device may send the computer-generated perceptual information via the data channel to the wireless communication node. A media function (e.g., a DC media function) of the wireless communication node may communicate the computer-generated perceptual information to a rendering function (e.g., an AR rendering function) of the wireless communication node. The rendering function may store the computer-generated perceptual information.

In some embodiments, the first wireless communication device may send the media content to the wireless communication node (e.g., an AR rendering function of the application server). A rendering function of the wireless communication node may render the media content with the computer-generated perceptual information. The data channel may comprise an application data channel. The computer-generated perceptual information may comprise augmented reality (AR) specific data. The media channel may comprise a real-time transport protocol (RTP) channel. The media content may comprise an audio media content or a video media content.

In some embodiments, a wireless communication node (e.g., an application server) may communicate with a first wireless communication device (e.g., a UE) to share computer-generated perceptual information (e.g., AR specific data) via a data channel (e.g., an application data channel). A media content can be rendered with the computer-generated perceptual information.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a sequence diagram for augmented reality (AR) communication, in accordance with some embodiments of the present disclosure;

FIG. 4 illustrates a sequence diagram for augmented reality (AR) communication, in accordance with some embodiments of the present disclosure;

FIG. 5 illustrates a block diagram of an example method for augmented reality (AR) communication, in accordance with some embodiments of the present disclosure; and

FIG. 6 illustrates a flow diagram for augmented reality (AR) communication, in accordance with an embodiment of the present disclosure.

### DETAILED DESCRIPTION

### 1. Mobile Communication Technology and Environment

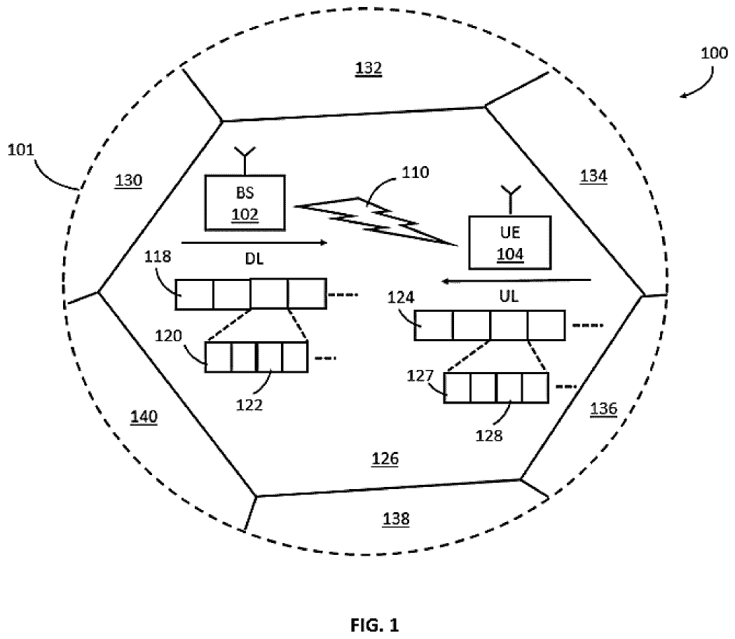

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

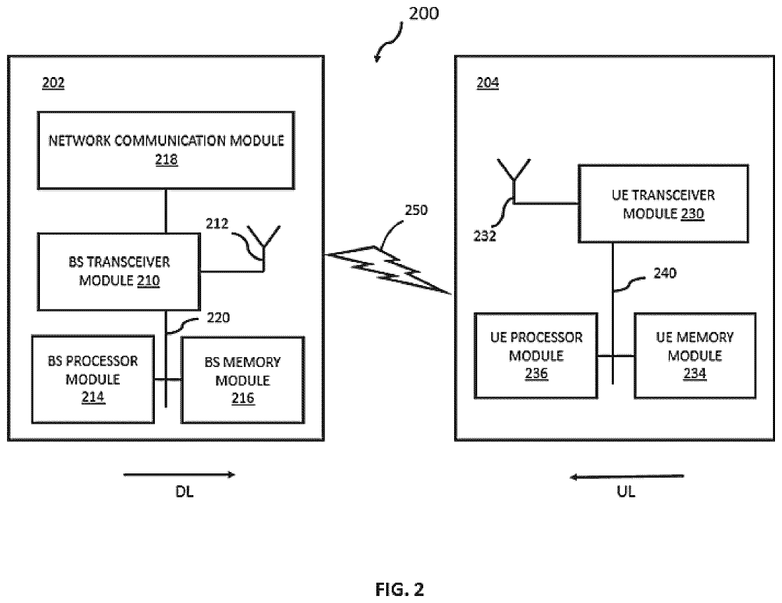

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Augmented Reality (AR) Communication Based on Data Channel

A data channel may enhance an ability of internet protocol multimedia subsystem (IMS) to handle interactions between user equipments (UEs) or between a UE and an application server in a network. The data channel can be highly flexible. The data channel can carry any type of information. An augmented reality (AR) communication may bring good experience to a user with an AR enabled device, such as AR glasses, or a mobile phone with an AR capability. In the AR communication, some AR specific data (sometimes referred to as computer-generated perceptual information) can be used to render a video content exchanged between the users. The rendered video may bring/provide auxiliary information for the users. A technical problem is how can a data channel be used to support an AR communication for exchanging or transmitting AR specific data. The systems and methods presented herein include novel approaches for augmented reality (AR) communication based on a data channel.

A communication service provider may offer new services (e.g., screen sharing, visual interactive menu, and/or location sharing during calling). An IMS data channel may transfer different kinds of media types and can be used in parallel with other multi-media types, such as voice or video in a telephony service. This data channel can be highly flexible and can carry any type of information between a UE and a network, and/or end-to-end between UEs.

AR may composite virtual objects with reality. AR content may include one or more AR objects which can overlap on a reality scene. AR communication may provide a functionality for one user to share video of reality rendered using some AR objects to other users. The AR objects can be marks, stickers, cartoon characters, virtual human models, or 3D models used to render the objects in the scene. The AR specific data can be AR objects, or data/information used to create the AR objects. In AR communication, a data channel can be used to transfer the AR specific data between UEs and the network. The AR specific data can be taken/used as resources to render (together with) video or other content shared by the users. The present disclosure provides functions and procedures of an AR communication based on a data channel.

A data channel can be used to transfer AR specific data during an AR communication. The AR specific data may include a mark, a sticker, a cartoon character, a virtual human model, or a 3D model used to render objects in a scene. A rendering operation can be performed by a UE or by an AR rendering function on a network side. For the UE rendering option, the UE may first download AR specific data from the network. The UE may render a received video media content from a peer UE and may display the video media content to the user. The UE may render a local captured video and may send the local captured video to the peer UE. For the network rendering option, the UE may send a video content to an AR rendering function in the network. The AR rendering function may render the video content using the stored AR specific data and may send the video content to the peer UE.

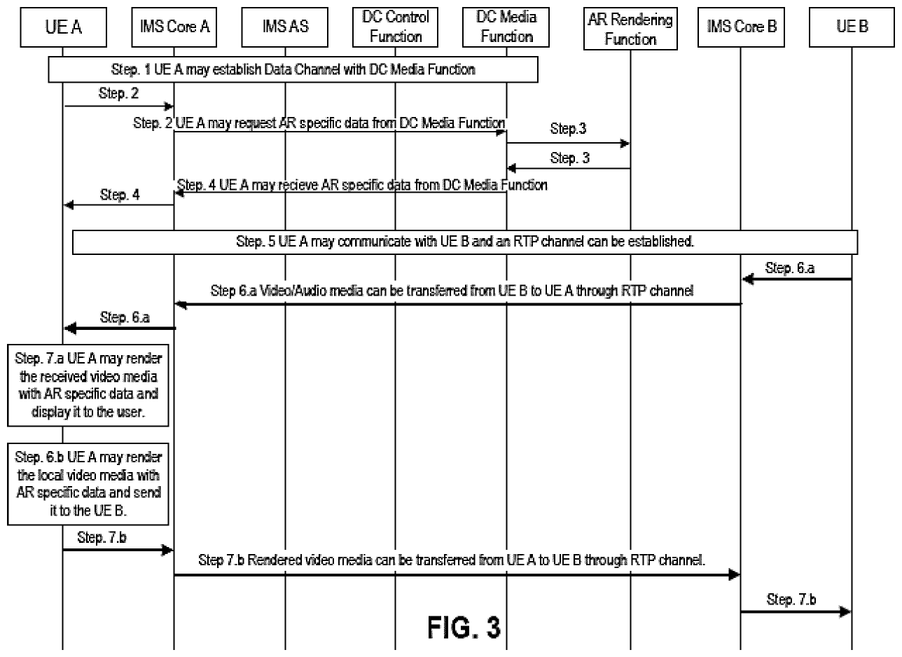

To support an AR communication based on a data channel (of a wireless cellular network or connection), the following functions can be added to an IMS architecture: a data channel (DC) control function may implement data channel business logic including initiating and terminating data channel control procedures; a DC media function may execute IMS data channel media operations (e.g., creation and closure of data channel(s)), and/or may transfer AR specific data from a AR rendering function to a UE; or a AR rendering function may render video media content based on the AR specific data and may provide a repository of AR specific data. The procedures for UE rendering using computer-generated perceptual information (e.g., AR specific data) transferred by the data channel are shown in FIG. 3 in an example implementation.

### Implementation Example 1: Procedure for UE Rendering Using AR Specific Data Transferred Via Data Channel

FIG. 3 illustrates a sequence diagram for augmented reality (AR) communication, in accordance with some embodiments of the present disclosure.

In step 1, a UE A may establish a data channel with a data channel (DC) media function. The UE A may interact with functions in an internet protocol multimedia subsystem (IMS) core A, an IMS application server (IMS AS), a DC control function, and a DC media function to establish a data channel between the UE A and the DC Media Function. The data channel may include two types: a bootstrap data channel and an application data channel. The bootstrap data channel can be established first in the step 1. An application can be downloaded through the bootstrap data channel from the DC media function to the UE A. After triggering by the application, the UE A may establish the application data channel to transfer computer-generated perceptual information or AR specific data between the IMS core A, the IMS AS, the DC control function, and/or the DC media function.

In step 2, the UE A may request AR specific data from the DC media function through the data channel established in step 1.

In step 3, the DC media function may interact with the AR rendering function to acquire the AR specific data from its repository.

In step 4, the DC media function may send the AR specific data through the data channel to the UE A.

In step 5, the UE A may communicate with a UE B. A real-time transport protocol (RTP) channel can be established between the UE A and the UE B to exchange a media content (e.g., an audio or a video media content). This step can be executed before the establishment of data channel or in parallel with the data channel establishment.

In step 6a, the video or audio media content can be transferred from the UE B to the UE A through the RTP channel.

In step 7a, the UE A may render (e.g., combine/process/format) the received video media content (together/combined) with the AR specific data (e.g., into a displayable form), and may display the video media content to a user via an AR device.

In step 6b, the UE A may render a local video media content (e.g., locally generated/accessed/retrieved/acquired at UE A) with the AR specific data. The UE A may send the (rendered) local video media content (e.g., after rendering/processing) to the UE B (e.g., for display). In certain embodiments, for a rendering process that is to use real-time AR specific data, the procedures of step 6a or step 6b can be executed in parallel with step 4.

In step 7b, the rendered video media content can be transferred from the UE A to the UE B through the RTP channel.

### Implementation Example 2: Procedure for Network Rendering Using AR Specific Data Transferred by Data Channel

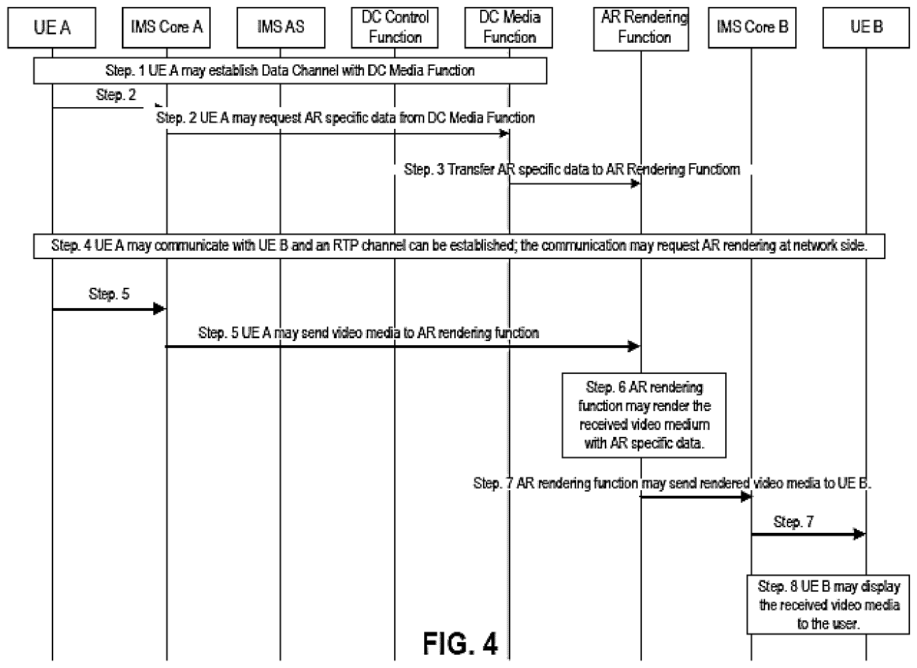

FIG. 4 illustrates a sequence diagram for augmented reality (AR) communication, in accordance with some embodiments of the present disclosure

In step 1, a UE A may establish a data channel with a data channel (DC) media function. The UE A may interact with functions in an internet protocol multimedia subsystem (IMS) core A, an IMS application server (IMS AS), a DC control function, and/or a DC media function to establish a data channel between the UE A and the DC Media Function. The data channel may have two types: a bootstrap data channel and an application data channel. The bootstrap data channel can be established first in the step 1. An application can be downloaded through the bootstrap data channel from the DC media function to the UE A. After triggering by the application, the UE A may establish the application data channel to transfer computer-generated perceptual information or AR specific data between the IMS core A, the IMS AS, the DC control function, and/or the DC media function.

In step 2, the UE A may upload/provide AR specific data to the DC media function.

In step 3, the DC media function may transfer/send/provide the AR specific data to the AR rendering function. The AR rendering function may store/maintain the AR specific data in a local repository.

In step 4, the UE A may communicate with a UE B. A real-time transport protocol (RTP) channel can be established between the UE A and the UE B to exchange media content (e.g., an audio or a video media content). The UE A to UE B communication may request AR rendering to be performed at the network side.

In step 5, the UE A may send audio or video media content through the RTP channel. The audio/video media content which is to be rendered can be sent to the AR rendering function.

In step 6, the AR rendering function may render the received video/audio media with the AR specific data. The AR specific data used in step 6 can be the data uploaded by the UE A in any step of steps 1 to 3. In some embodiments, the data can be formerly stored in the AR rendering function.

In step 7, the AR rendering function may send the rendered video/audio content to the UE B (e.g., for display).

In step 8, the UE B may display the received (rendered) video/audio media content to a user via an AR device.

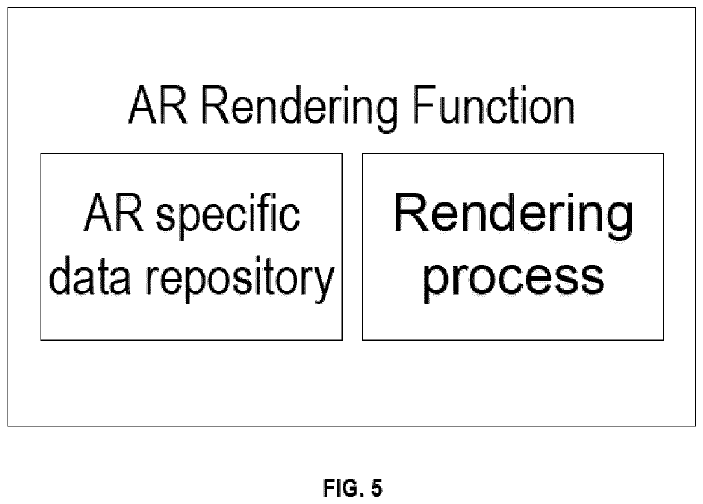

FIG. 5 illustrates a block diagram of an example method for augmented reality (AR) communication, in accordance with some embodiments of the present disclosure. An architecture of an AR rendering function is shown in FIG. 5. A rendering process may render video/audio (or other) media content based on AR specific data. An AR specific data repository may provide a storage function for the AR specific data.

It should be understood that one or more features from the above implementation examples are not exclusive to the specific implementation examples, but can be combined in any manner (e.g., in any priority and/or order, concurrently or otherwise).

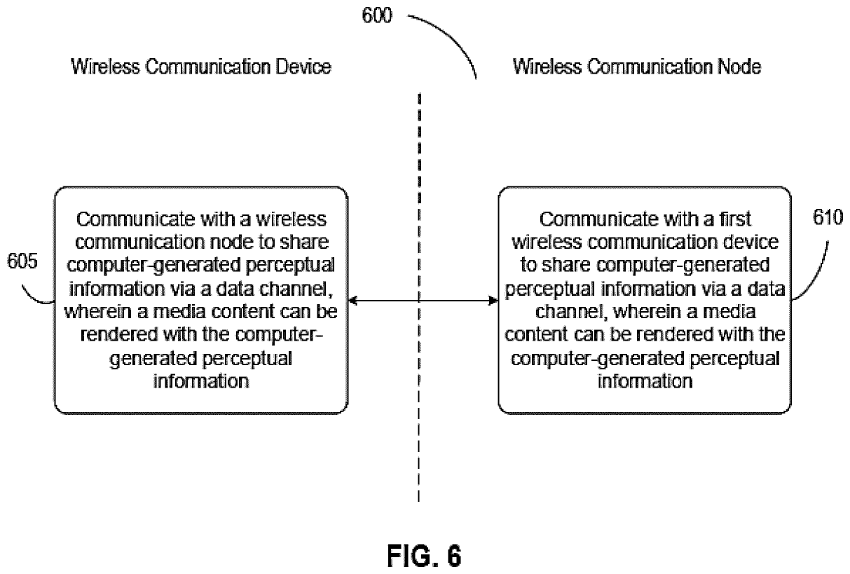

FIG. 6 illustrates a flow diagram for augmented reality (AR) communication, in accordance with an embodiment of the present disclosure. The method 600 may be implemented using any one or more of the components and devices detailed herein in conjunction with FIGS. 1-2. In overview, the method 600 may be performed by a wireless communication device, in some embodiments. Additional, fewer, or different operations may be performed in the method 600 depending on the embodiment. At least one aspect of the operations is directed to a system, method, apparatus, or a computer-readable medium.

A first wireless communication device (e.g., a user equipment (UE)) may communicate with a wireless communication node (e.g., an application server) to share computer-generated perceptual information (e.g., AR specific data, which can be locally generated, or received from a UE B) via a data channel (e.g., an application data channel). A media (e.g., an audio media or a video media) content can be rendered (e.g., to combine media content with AR specific data, or to process/augment the media content using the AR specific data) with the computer-generated perceptual information. A media function (e.g., a data channel (DC) media function) of the wireless communication node can communicate with a rendering function (e.g., an AR rendering function) of the wireless communication node to acquire the computer-generated perceptual information, and/or to send the computer-generated perceptual information to the wireless communication device (e.g., to perform rendering).

In some embodiments, the first wireless communication device may establish the data channel with the wireless communication node. The first wireless communication device may send a request for the computer-generated perceptual information via the data channel to the wireless communication node. The first wireless communication device may receive the computer-generated perceptual information via the data channel from the wireless communication node, e.g., to perform rendering.

In some embodiments, the first wireless communication device may generate (e.g., locally generate) the media content. The first wireless communication device may render the media content with/using the computer-generated perceptual information. The first wireless communication device (e.g., a UE A) may send the rendered media content via a media channel (e.g., a real-time transport protocol (RTP) channel) to a second wireless communication device (e.g., a UE B), e.g., for display/rendering/output to a user.

In some embodiments, the first wireless communication device may receive the media content via a media channel from a second wireless communication device. The first wireless communication device may render the received media content with the computer-generated perceptual information. The first wireless communication device may send the computer-generated perceptual information via the data channel to the wireless communication node. A media function (e.g., a DC media function) of the wireless communication node may communicate the computer-generated perceptual information to a rendering function (e.g., an AR rendering function) of the wireless communication node. The rendering function may store the computer-generated perceptual information.

In some embodiments, the first wireless communication device may send the media content to the wireless communication node (e.g., an AR rendering function of the application server). A rendering function of the wireless communication node (instead of the first wireless communication device) may render the media content with the computer-generated perceptual information. The wireless communication node (e.g., AR rendering function) may send the rendered media content to the second wireless communication device (e.g., for display/rendering/output to a user). The data channel may comprise an application data channel. The computer-generated perceptual information may comprise augmented reality (AR) specific data. The media channel may comprise a real-time transport protocol (RTP) channel. The media content may comprise an audio media content and/or a video media content.

In some embodiments, a wireless communication node (e.g., an application server) may communicate with a first wireless communication device (e.g., a UE) to share (e.g., receive/access or provide/send) computer-generated perceptual information (e.g., AR specific data) via a data channel (e.g., an application data channel). A media content can be rendered (e.g., at the wireless communication node, or at an AR rendering function of the application server) with/using the computer-generated perceptual information.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising:
communicating, by a first wireless communication device, with a wireless communication node to share computer-generated perceptual information via a data channel,
wherein a media content is rendered with the computer-generated perceptual information.

2. The method of claim 1, wherein a media function of the wireless communication node communicates with a rendering function of the wireless communication node to acquire the computer-generated perceptual information, and to send the computer-generated perceptual information to the wireless communication device.

3. The method of claim 1, comprising:
establishing, by the first wireless communication device, the data channel with the wireless communication node.

4. The method of claim 1, comprising:
sending, by the first wireless communication device to the wireless communication node, a request for the computer-generated perceptual information via the data channel.

5. The method of claim 1, comprising:
receiving, by the first wireless communication device from the wireless communication node, the computer-generated perceptual information via the data channel.

6. The method of claim 1, comprising:
generating, by the wireless communication device, the media content;
rendering, by the first wireless communication device, the media content with the computer-generated perceptual information; and
sending, by the first wireless communication device to a second wireless communication device, the rendered media content via a media channel.

7. The method of claim 1, comprising:
receiving, by the first wireless communication device from a second wireless communication device, the media content via a media channel; and
rendering, by the first wireless communication device, the received media content with the computer-generated perceptual information.

8. The method of claim 1, comprising:
sending, by the first wireless communication device to the wireless communication node, the computer-generated perceptual information via the data channel.

9. The method of claim 8, wherein a media function of the wireless communication node communicates the computer-generated perceptual information to a rendering function of the wireless communication node, and the rendering function stores the computer-generated perceptual information.

10. The method of claim 8, comprising:
sending, by the first wireless communication device to the wireless communication node, the media content,
wherein the wireless communication node renders the media content with the computer-generated perceptual information.

11. The method of claim 10, wherein a rendering function of the wireless communication node renders the media content with the computer-generated perceptual information.

12. The method of claim 1, wherein the data channel comprises an application data channel.

13. The method of claim 1, wherein the computer-generated perceptual information comprises augmented reality (AR) specific data.

14. The method of claim 6, wherein the media channel comprises a real-time transport protocol (RTP) channel.

15. The method of claim 1, wherein the media content comprises an audio media content or a video media content.

16. A method, comprising:
communicating, by a wireless communication node, with a first wireless communication device to share computer-generated perceptual information via a data channel,
wherein a media content is rendered with the computer-generated perceptual information.

17. The method of claim 16, wherein a media function of the wireless communication node communicates with a rendering function of the wireless communication node to acquire the computer-generated perceptual information, and to send the computer-generated perceptual information to the wireless communication device.

18. The method of claim 16, comprising:
establishing, by the wireless communication node with the first wireless communication device, the data channel.

19. A first wireless communication device, comprising:
a transceiver configured to:
communicate with a wireless communication node to share computer-generated perceptual information via a data channel,
wherein a media content is rendered with the computer-generated perceptual information.

20. A wireless communication node, comprising:
a transceiver configured to:
communicate with a first wireless communication device to share computer-generated perceptual information via a data channel,
wherein a media content is rendered with the computer-generated perceptual information.
